(19) United States
(12) Patent Application Publication
(10) Pub. No.: US 2011/0012895 A1
(43) Pub. Date: Jan. 20, 2011

(54) Processing Hogel Data

(75) Inventors: Mark E. Lucente, Austin, TX (US); Thomas Lawrence Burnett, III, Austin, TX (US); Shih-Che Huang, Austin, TX (US); Kendall James, Austin, TX (US); Salah U. Din, Austin, TX (US)

Correspondence Address: Georgios A. Georgakis;Chowdhury & Georgakis, PC, PO BOX 90277, AUSTIN, TX, 78709-0277, US

(73) Assignee: ZEBRA IMAGING, INC., Austin, TX (US)

(21) Appl. No.: 12/819,248

(22) Filed: Jun. 21, 2010

Related U.S. Application Data
(63) Continuation of application No. 12/606,137, filed on Oct. 26, 2009.
Application No. 12/606,137 is a continuation of application No. 12/606,099, filed on Oct. 26, 2009.
Application No. 12/606,099 is a continuation of application No. 12/546,049, filed on Aug. 24, 2009.
(60) Provisional application No. 61/108,549, filed on Oct. 26, 2008.

(51) Int. Cl. G06T 15/00

(52) U.S. Cl. 345/419

(57) ABSTRACT

Methods and systems for processing hogel data including providing a set of hogel data, providing one or more properties of a hogel light modulator, and processing the set of hogel data according to the one or more properties of the hogel display.

### II. PRIORITY CLAIM

This application is a continuation of and claims priority from:
U.S. patent application Ser. No. 12,606,137, filed 26 Oct. 2009, titled “Rendering 3D Data to Hogel Data” and naming Gary Anthony McLroy Jr., et. al, as inventor(s), which in-turns claims priority from
U.S. patent application Ser. No. 12,606,099, filed 26 Oct. 2009, titled “Rendering 3D Data to Hogel Data” and naming Michael E. Weiblen, et. al, as inventor(s), which in-turns claims priority from
U.S. patent application Ser. No. 12,546,049, filed 24 Aug. 2009, titled “Converting 3D Data to Hogel Data” and naming Wesley A. Holler, et. al, as inventor(s), which in-turns claims priority from
U.S. Provisional Application No. 61/108,549, filed 26 Oct. 2008, titled “Systems and Methods for Converting 3D Data to Hogel Data” and naming Michael E. Weiblen, et. al, as inventor(s).

The above-referenced patents and/or patent applications are hereby incorporated by reference herein in their entirety.

### I. GOVERNMENT CONTRACT STATEMENT

The U.S. Government has a paid-up license in this invention and the right in limited circumstances to require the patent owner to license others on reasonable terms as provided for by the terms of contract No. N61339-06-C-0165 awarded by DARPA.

### III. BACKGROUND

The invention relates generally to the field of rendering hogels and particularly to the field of processing hogel data.

### IV. SUMMARY

In one respect, disclosed is a method for processing hogel data, the method comprising providing a set of hogel data, providing one or more properties of a hogel light modulator, and processing the set of hogel data according to the one or more properties of the hogel display.

In another respect, disclosed is a system for processing hogel data, the system comprising: one or more processors; and one or more memory units coupled to the processor, the system being configured to: be provided a set of hogel data, be provided one or more properties of a hogel light modulator, and process the set of hogel data according to the one or more properties of the hogel display.

In yet another respect, disclosed is a computer program product stored on a computer operable medium, the computer program product comprising software code being effective to: be provided a set of hogel data, be provided one or more properties of a hogel light modulator, and process the set of hogel data according to the one or more properties of the hogel display.

Numerous additional embodiments are also possible. In one or more various aspects, related articles, systems, and devices include but are not limited to circuitry, programming, electro-mechanical devices, or optical devices for effecting the herein referenced method aspects; the circuitry, programming, electro-mechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### V. BRIEF DESCRIPTION OF THE DRAWINGS

Other aspects and advantages of the invention may become apparent upon reading the detailed description and upon reference to the accompanying drawings.

FIG. 1 is a block diagram illustrating a system for processing hogel data, in accordance with some embodiments.

FIG. 2 is a block diagram illustrating an alternative system for processing hogel data, in accordance with some embodiments.

FIG. 3 is a flow diagram illustrating a method for processing hogel data, in accordance with some embodiments.

FIG. 4 is a flow diagram illustrating an alternative method for processing hogel data, in accordance with some embodiments.

FIG. 5 is a flow diagram illustrating a method for synchronizing the displaying of hogel data processed at multiple hogel data processing nodes, in accordance with some embodiments.

Brief description for the additional figures is provided in the detailed description section.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### VI. DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device couples to a second device, that connection may be through a direct electrical, optical, wireless connection, etc. or through an indirect electrical, optical, wireless connection, etc. by means of other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

In some embodiments, systems and methods are disclosed for processing hogel data that is to be displayed on a hogel light modulator, for example. Various types of processing may be applied to the hogel data in order to prepare the hogel data for displaying on the hogel light modulator. In some embodiments, the processing may enable the displaying of the hogel data on the hogel light modulator, increase the quality of the displaying, enable various visual effects, etc. It should also be noted that in embodiments where the hogel data may represent 3D movies, the hogel data may be received

[insert references to hogels and hogel light modulators.]

In some embodiments, prior to processing, the hogel positions associated with the hogel data may correspond to a particular set of locations on the holographic surface. In addition, each hogel may comprise multiple hogel beams that may correspond to a particular set of stereo angles. It should be noted that generally the holographic surface may be any 2D surface and the hogel data may correspond to locations on the holographic surface that do not necessarily form a regular grid. Similarly, the hogel beams may not necessarily form a regular angular grid.

In some embodiments, the hogel light modulator may be configured to display hogel data having hogels that correspond to particular locations with the hogels having hogel beams that correspond to particular stereo angles. The hogel locations and hogel beam angles that the hogel light modular may support may not necessarily correspond to the ones for the hogel data to be displayed on the hogel light modulator. Processing therefore may be required in order to resample or interpolate the hogel data to correspond to locations and angles supported by the hogel light modulator. In some embodiments, the processing may be performed using processes similar to the processes for resampling pixels for displaying on 2D light modulators. For example, color and intensity for a hogel beam may be determined by interpolating neighboring hogel beams. [any other ideas here?]

In some embodiments, higher order resampling and interpolation of the hogel positions and hogel beams angles may also be used in order to account for non-uniformities and specific characteristics in the hogel light modulator. Non-uniformities and specific characteristics may be especially present in cases where the display is constructed using multiple smaller displays that are tiled together to form a bigger display.

In some embodiments, the color and intensity profile used for the hogel data may not correspond to the color and intensity profile used by the hogel light modulator. Processing may be applied to the hogel data to convert the color and intensity values to the profile corresponding to the hogel light modulator.

In some embodiments, additional processing may also be applied on the hogel data. For example, depending on the structure of the hogel light modulator, certain hogel beams may be set to 0 color and intensity. Such masking processes may be applied, for example, to turn off hogel beams on the edges of hogels that may interfere with hogel beams from neighboring hogels or with other components in the hogel light modulator. Additional processing may also include blending two or more sets of hogels together to create composite 3D images, for example.

In some embodiments, higher order may also be used in order to account for non-uniformities and specific characteristics in the hogel light modulator. As previously discussed, non-uniformities and specific characteristics may be especially present in cases where the display is constructed using multiple smaller displays that are tiled together to form a bigger display.

In embodiments where the hogel data may represent a 3D movie, the hogel data may be processed one frame at a time. In these embodiments, the hogel data may also be displayed substantially synchronously a frame at a time.

In some embodiments, the hogel data processing may be performed using one or more hogel data processing nodes. Processing of hogel data within each processing node may be performed in series and/or in parallel and processing across multiple processing nodes may be performed in parallel. Accordingly, in some embodiments, the processing of the hogel data may also include synchronization processing to ensure that processed hogel data frames (when hogel data movies are involved, for example) are substantially simultaneously displayed on the hogel light modulator even different portions of the hogel data are processed at different times.

In some embodiments, synchronization may be accomplished by waiting for a processing complete command from all the processing nodes to which hogel data processing may be assigned. Once each of the rendering nodes have issued a processing complete command, all the processed data may be substantially synchronously displayed on a hogel light modulator.

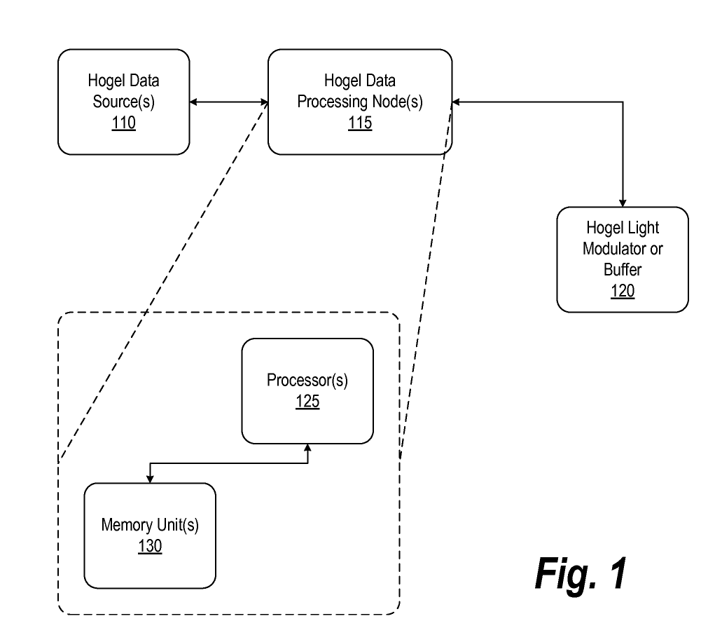

FIG. 1 is a block diagram illustrating a system for processing hogel data, in accordance with some embodiments.

In some embodiments, one or more hogel data sources 110 are configured to provide hogel data to one or more hogel data processing nodes 115. Hogel data sources 110 may be configured to, in some embodiments, store and/or generate the hogel data. Hogel data sources 110 may represent multiple rendering nodes configured to generate (using other forms of 3D data, for example) and buffer hogel data.

In some embodiments, each of the hogel data sources may be coupled to a corresponding hogel data processing node. In other embodiments, more than one hogel data processing node may be coupled to a single hogel data source, and in yet other embodiments, more than one hogel data source may be coupled to a single hogel data processing node. In yet additional embodiments, a certain number of hogel data sources may share a certain number of hogel data processing nodes.

In some embodiments, hogel data processing nodes 115 may comprise one or more processors 125 and one or more memory units 130 coupled to one or more processors 125. In some embodiments, one or more processors 125 and one or more memory units 130 are configured to implement the functionality of hogel data processing nodes 115. In other embodiments, one or more processors 125 and one or more memory units 130 may be configured to implement the functionality of the whole system, including the functionality of one or more hogel data sources 110.

In some embodiments, the processed hogel data may be provided to hogel light modulator 120 for display. In alternative embodiments, the processed hogel data may be stored in a buffer so that the hogel data may be processed and/or displayed at a later time.

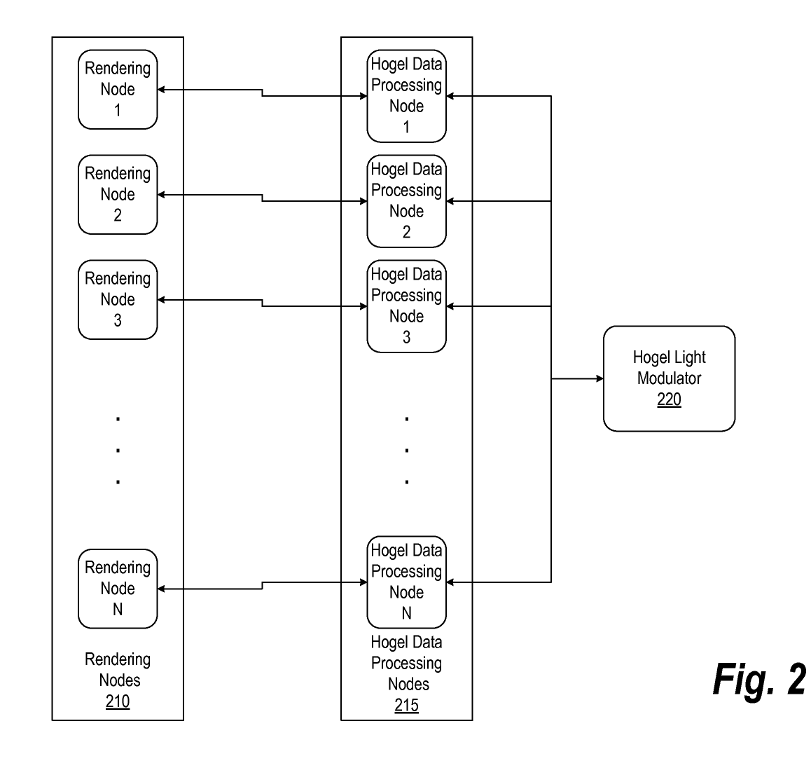

FIG. 2 is a block diagram illustrating an alternative system for processing hogel data, in accordance with some embodiments. In some embodiments, FIG. 2 represents an alternative implementation of hogel data processing node configured to process hogel data.

In some embodiments, rendering nodes 210 comprise rendering nodes 1-N that are configured to each render a portion of sets of hogel data. In embodiments where the hogel data may represent 3D movies, each set of hogel data may represent a frame, for example. In some embodiments, each rendering node may be configured to render hogel data using 3D computer graphics data and commands.

In some embodiments, each of rendering nodes 1-N is coupled to a corresponding hogel data processing node 1-N, where hogel data processing nodes 1-N are part of hogel data processing node 215. In some embodiments, each of hogel data processing nodes 1-N is configured to receive and process a portion of a hogel data set. The hogel data processing may comprise, for example, resampling of the hogel locations and/or hogel beam angles, processing the hogel data values color and intensity profile, etc.

In some embodiments, the processed hogel data may be provided to hogel light modulator 220 for display. In alternative embodiments, the processed hogel data may be stored in a buffer so that the hogel data may be processed and/or displayed at a later time.

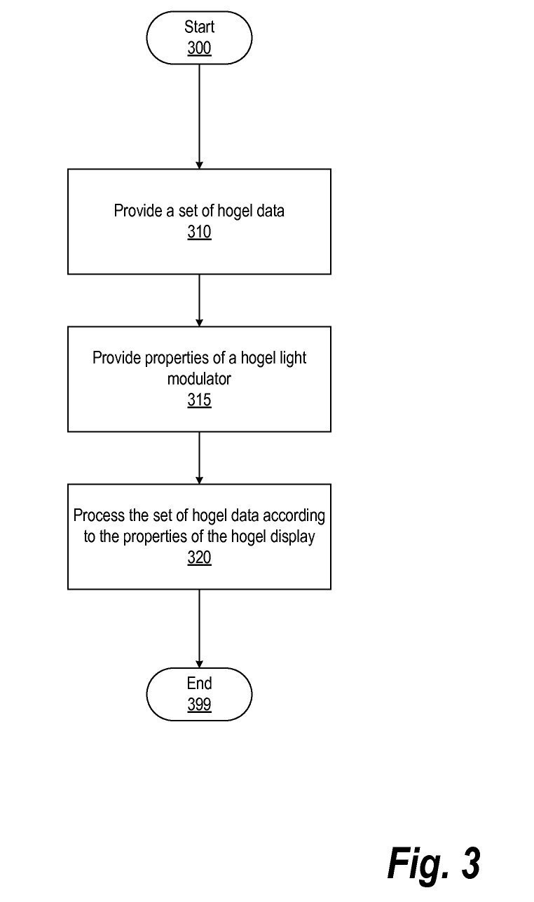

FIG. 3 is a flow diagram illustrating a method for processing hogel data, in accordance with some embodiments. It should be noted that, in some embodiments, the methods described here may be performed by the system described in FIG. 1 though FIG. 2.

Processing begins at 300 where, at block 310, a set of hogel data is provided. In some embodiments, the hogel data may comprise hogels corresponding to specific locations, each hogel having hogel beams corresponding to specific angles. In addition, the hogel data values may correspond to a particular color and intensity profile. In some embodiments, hogel data may be provided a frame at a time.

At block 315, properties of a hogel light modulator are provided. In some embodiments, the hogel light modulator may be configured to display hogel data with hogels corresponding to specific locations, each hogel having hogel beams corresponding to specific angles. In addition, the hogel light modulator may be configured such that the hogel data values may correspond to a particular color and intensity profile.

At block 320, the set of hogel data is processed according to the properties of the hogel display. In some embodiments, the hogel data is processed such that one or more of the properties of the hogel data match the corresponding properties of the hogel light modulator. In some embodiments, one or more of the hogel locations, the hogel beam angles, the hogel data values color and the intensity profile, etc. may be processed in order for the hogel data to be displayed properly on the hogel light modulator.

Processing subsequently ends at 399.

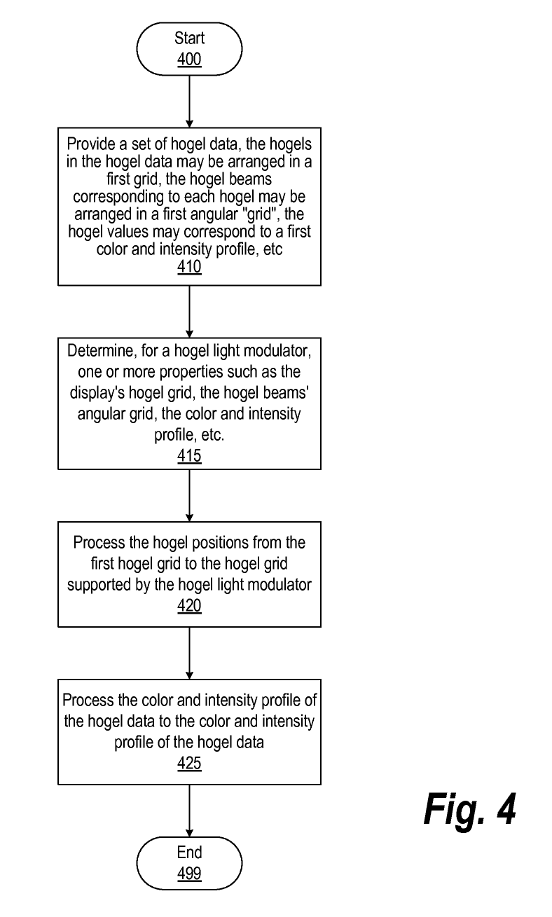

FIG. 4 is a flow diagram illustrating an alternative method for processing hogel data, in accordance with some embodiments. It should be noted that, in some embodiments, the methods described here may be performed by the system described in FIG. 1 though FIG. 2.

Processing begins at 400 where, at block 410, a set of hogel data is provided. In some embodiments, the hogels in the hogel data may be arranged in a grid, the hogel beams corresponding to each hogel may be arranged in an angular “grid”, the hogel values may correspond to a color and intensity profile, etc.

At block 415, one or more properties of a hogel light modulator are determined such as the display's hogel grid, the hogel beams' angular grid, the color and intensity profile, etc.

At block 420, the hogel locations as well as the hogel beam angles are processed in order to be matched to the native hogel locations and hogel beam angles of the hogel light modulator.

At block 425, the hogel data values are processed to ensure that the hogel data values correspond to the color and intensity profile of the hogel light modulator.

Processing subsequently ends at 499.

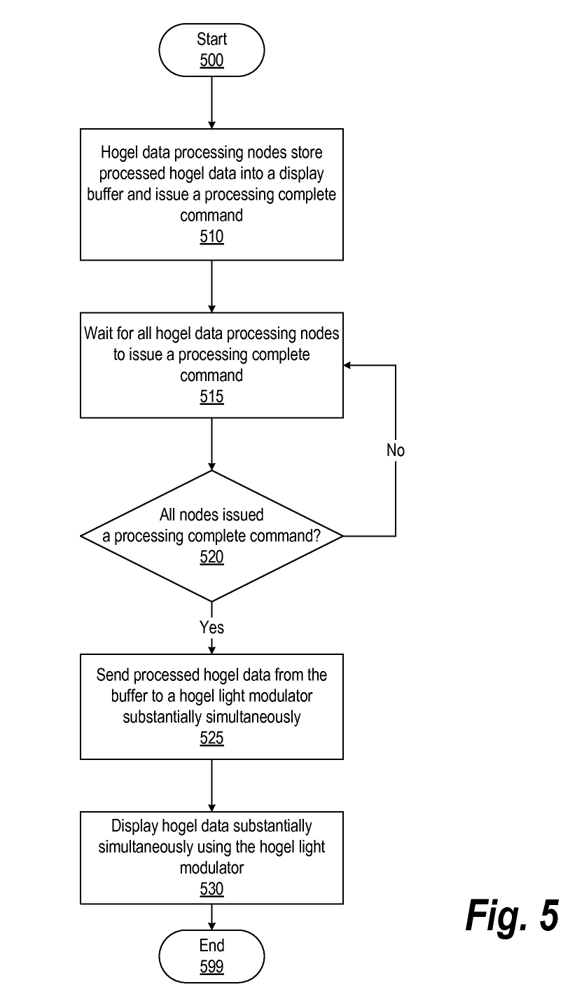

FIG. 5 is a flow diagram illustrating a method for synchronizing the displaying of hogel data processed at multiple hogel data processing nodes, in accordance with some embodiments. It should be noted that, in some embodiments, the methods described here may be performed by the system described in FIG. 1 though FIG. 2.

Processing begins at 500 where, at block 510, hogel data processing nodes store processed hogel data into a buffer (such as a display buffer, for example) as each node completes processing of a subset of the hogel data. After a hogel data processing node completes the processing, the hogel data processing node issues a processing complete command.

At block 515, the system waits for all of the hogel data processing nodes to issue a processing complete command. At decision 520, a determination is made as to whether all of the hogel data processing nodes have issued a processing complete command. If not all of the nodes have issued a processing complete command, decision 520 branches to the “no” branch where, at block 515, the system waits for all of the hogel data processing nodes to issue a processing complete command.

On the other hand, if all the nodes have issued a processing complete command, decision 520 branches to the “yes” branch where, at block 525, the processed hogel data is sent from the buffer to a hogel light modulator substantially simultaneously.

At block 530, the hogel data is displayed substantially simultaneously using a hogel light modulator.

Processing subsequently ends at 599.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for processing hogel data, the method comprising:
providing a set of hogel data;
providing one or more properties of a hogel light modulator; and
processing the set of hogel data according to the one or more properties of the hogel display.

2. The method of claim 1, where processing the set of hogel data enables the displaying of the set of hogel data on the hogel light modulator.

3. The method of claim 1, where processing the set of hogel data improves a quality of displaying the set of hogel data on the hogel light modulator.

4. The method of claim 1, where the properties of the hogel display comprises at least one of:
hogel locations and hogel beam angles supported by the display; and
color and intensity response.

5. The method of claim 1, where processing comprises at least one of:
processing the hogel locations and the hogel beams angles; and
processing the color and intensity profile of one or more hogel data values.

6. The method of claim 5, where processing comprises applying a mask to the one or more hogel data values.

7. A system for processing hogel data, the system comprising:
one or more processors;
one or more memory units coupled to the processor, and
the system being configured to:
be provided a set of hogel data;
be provided one or more properties of a hogel light modulator; and
process the set of hogel data according to the one or more properties of the hogel display.

8. The system of claim 7, where the system being configured to process the set of hogel data enables the displaying of the set of hogel data on the hogel light modulator.

9. The system of claim 7, where the system being configured to process the set of hogel data improves a quality of displaying the set of hogel data on the hogel light modulator.

10. The system of claim 7, where the properties of the hogel display comprises at least one of:
hogel locations and hogel beam angles supported by the display; and
color and intensity response.

11. The system of claim 7, where the system being configured to process comprises the system being configured to perform at least one of:
process the hogel locations and the hogel beams angles; and
process the color and intensity profile of one or more hogel data values.

12. The system of claim 11, where the system being configured to process comprises the system being configured to apply a mask to the one or more hogel data values.

13. A computer program product stored on a computer operable medium, the computer program product comprising software code being effective to:
be provided a set of hogel data;
be provided one or more properties of a hogel light modulator; and
process the set of hogel data according to the one or more properties of the hogel display.

14. The product of claim 13, where the software code being effective to process the set of hogel data enables the displaying of the set of hogel data on the hogel light modulator.

15. The product of claim 13, where the software code being effective to process the set of hogel data improves a quality of displaying the set of hogel data on the hogel light modulator.

16. The product of claim 13, where the properties of the hogel display comprises at least one of:
hogel locations and hogel beam angles supported by the display; and
color and intensity response.

17. The product of claim 13, where the software code being effective to process comprises the software code being effective to perform at least one of:
process the hogel locations and the hogel beams angles; and
process the color and intensity profile of one or more hogel data values.

18. The product of claim 17, where the software code being effective to process comprises the software code being effective to apply a mask to the one or more hogel data values.
